(19) United States
(12) Patent Application Publication
(10) Pub. No.: US 2010/0245632 A1
(43) Pub. Date: Sep. 30, 2010

(54) NOISE REDUCTION METHOD FOR VIDEO SIGNAL AND IMAGE PICKUP APPARATUS

(75) Inventor: Hiroshi SUZUKI, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/748,945

(22) Filed: Mar. 29, 2010

(30) Foreign Application Priority Data
Mar. 31, 2009 (JP) 2009-086695

(51) Int. Cl. H04N 5/217; H04N 5/00

(52) U.S. Cl. 348/241; 348/607; 348/E05.078

(57) ABSTRACT

A noise reduction method for a video signal including a shooting step of shooting a subject by a CCD and outputting a video signal, a distance information acquisition step of calculating a shooting distance between the subject and the CCD, a specific distance information acquisition step of calculating a specific distance which is a shooting distance between one subject of the subject and the CCD on the basis of focus information of the one subject, a relative distance calculation step of calculating a relative distance corresponding to the video signal on the basis of the shooting distance and the specific distance, and a noise reduction step, including a smoothing step of performing smoothing processing on the video signal on the basis of the relative distance, of performing noise reduction processing on the video signal on the basis of the relative distance.

### CROSS REFERENCE TO RELATED APPLICATION

This application claims the benefit of Japanese Application No. 2009-086695 filed in Japan on Mar. 31, 2009, the contents of which are incorporated by this reference.

### BACKGROUND OF THE INVENTION

1. Field of the Invention

The present invention relates to a noise reduction method for a video signal obtained by image pickup and an image pickup apparatus which performs processing by the noise reduction method and, more particularly, to a noise reduction method for a video signal based on a distance to a subject and an image pickup apparatus which performs processing by the noise reduction method.

2. Description of the Related Art

In an image pickup apparatus such as a digital camera, when a video signal obtained by image pickup is converted from an analog signal into a digital signal, noise is included in the video signal. If an image pickup device such as a CCD has a defective pixel or the like, fixed pattern noise is included in a video signal. For the reason, an image pickup apparatus performs noise reduction processing in order to reduce noise in a video signal.

For example, Japanese Patent Application Laid-Open Publication No. 2004-72422 discloses an image pickup system which estimates a noise amount included in a video signal in a region of interest using a model as a function of the noise amount with respect to the level of an inputted video signal, an ISO sensitivity, a gain or the like and performs noise reduction processing on the basis of the estimated noise amount.

In the image pickup system disclosed in Japanese Patent Application Laid-Open Publication No. 2004-72422, the noise amount expected to be included in an inputted video signal is formulated as a predetermined exponential function. The image pickup system determines coefficients of the exponential function by dynamically estimating the noise amount included in a video signal on the basis of pieces of information, such as a temperature of an image pickup device at the time of shooting, a gain, an exposure time, and white balance coefficients and performs noise reduction processing.

### SUMMARY OF THE INVENTION

A noise reduction method for a video signal according to an embodiment of the present invention includes a shooting step of shooting a subject by an image pickup section and outputting the video signal, a distance information acquisition step of calculating a shooting distance between the subject and the image pickup section corresponding to the video signal, a specific distance information acquisition step of calculating a specific distance which is a shooting distance between one subject of the subject and the image pickup section on the basis of focus information of the one subject, a relative distance calculation step of calculating a relative distance corresponding to the video signal on the basis of the shooting distance and the specific distance, and a noise reduction step of performing noise reduction processing on the video signal on the basis of the relative distance, the noise reduction step including a smoothing step of performing smoothing processing on the video signal on the basis of the relative distance.

An image pickup apparatus according to another embodiment of the present invention includes an image pickup section configured to shoot a subject and output a video signal, a distance measurement section configured to calculate a shooting distance between the subject and the image pickup section corresponding to the video signal, a specific distance acquisition section configured to calculate a specific distance which is a shooting distance between one subject of the subject and the image pickup section on the basis of focus information of the one subject, a relative distance calculation section configured to calculate a relative distance corresponding to the video signal on the basis of the shooting distance and the specific distance, and a noise reduction section configured to perform noise reduction processing by performing smoothing processing on the video signal on the basis of the relative distance.

An image pickup apparatus according to yet another embodiment of the present invention includes an image pickup section configured to shoot a subject and output a video signal, a distance measurement section configured to calculate a shooting distance between the subject and the image pickup section corresponding to the video signal, and a noise reduction section configured to calculate a distance weighting factor for the video signal from a difference between the shooting distance for a pixel of interest to be subjected to noise reduction processing and the shooting distance for a neighboring pixel which is a pixel within N pixels (N is an integer not less than 1) from the pixel of interest on the basis of the shooting distance, hold an edge component between regions with a shooting distance difference, and perform high-accuracy noise reduction processing on a video signal other than an edge component.

### BRIEF DESCRIPTION OF THE DRAWINGS

FIG. 1 is a configuration diagram of an image pickup apparatus according to a first embodiment of the present invention;

FIG. 2 is an explanatory chart showing a configuration of primary color filters;

FIG. 3 is a configuration diagram of a relative distance calculation section of the image pickup apparatus according to the first embodiment of the present invention;

FIG. 4 is an explanatory chart for explaining a video image;

FIG. 5 is a configuration diagram of a noise reduction section of the image pickup apparatus according to the first embodiment of the present invention;

FIG. 6 is a plot showing a shape of a threshold value calculation function for the image pickup apparatus according to the first embodiment of the present invention;

FIG. 7 is an explanatory graph of edge component determination processing by the image pickup apparatus according to the first embodiment of the present invention;

FIG. 8 is a configuration diagram showing a configuration of a noise reduction section according to a first modification of the first embodiment of the present invention;

FIG. 9A is a flow chart for explaining a flow of noise reduction processing by an image pickup apparatus according to the first modification of the first embodiment of the present invention;

FIG. 9B is a flow chart for explaining the flow of the noise reduction processing by the image pickup apparatus according to the first modification of the first embodiment of the present invention;

FIG. 10 is a configuration diagram showing a configuration of a noise reduction section according to a second modification of the first embodiment of the present invention;

FIG. 11 is a configuration diagram showing a configuration of a noise reduction section according to a third modification of the first embodiment of the present invention;

FIG. 12 is a configuration diagram showing a configuration of an image pickup apparatus according to a second embodiment of the present invention; and

FIG. 13 is a configuration diagram showing a configuration of a noise reduction section of the image pickup apparatus according to the second embodiment of the present invention.

### DETAILED DESCRIPTION OF THE PREFERRED EMBODIMENTS

### First Embodiment

An image pickup apparatus 1 according to a first embodiment of the present invention will be described below with reference to the drawings.

In the image pickup apparatus 1, a CCD 102 serving as an image pickup section shoots a subject 10 including one subject 10A and another one subject 10B of subjects through a lens system 100 and a diaphragm 101 and outputs an analog video signal. That is, video signals are a collection of signals for pixels, the number of which corresponds to the number of pixels of the CCD 102. A signal for a pixel may be simply referred to as a pixel hereinafter.

Note that, in the present specification, “the subject 10” alone means objects on a full screen shot by the CCD 102 and means neither the specific one subject 10A (e.g., a nearby person) nor the specific subject 10B (e.g., a distant mountain). That is, the subject 10 is composed of the plurality of specific subjects 10A and 10B at different shooting distances from the CCD 102. Analog video signals for the subject 10 outputted from the CCD 102 are converted into digital video signals by an A/D converter 104. The video signals outputted from the A/D converter 104 are transferred to a photometric evaluation section 106, a distance information acquisition section 108 serving as a distance measurement section, and a noise reduction section 110 through a buffer 105.

The photometric evaluation section 106 is connected to the diaphragm 101 and the CCD 102, and the distance information acquisition section 108 is connected to a lens control section 107 and a relative distance calculation section 109. The lens control section 107 is connected to an AF motor 103. The noise reduction section 110 is connected to an interpolation section 111, which is connected to a signal processing section 112. The signal processing section 112 is connected to a compression section 113, which is connected to an output section 114.

A control section 115 which is composed of a microcomputer or the like is bi-directionally connected to the A/D converter 104, the photometric evaluation section 106, the lens control section 107, the distance information acquisition section 108, the relative distance calculation section 109, the noise reduction section 110, the interpolation section 111, the signal processing section 112, the compression section 113, and the output section 114. An external I/F section 116 including a power switch (not shown), a shutter button (not shown) and an interface for switching shooting conditions such as a scene mode at the time of shooting or the like is also bi-directionally connected to the control section 115. Note that the shutter button of the image pickup apparatus 1 is composed of a two-step push button switch which works such that the image pickup apparatus 1 enters pre-shooting mode when the push button switch is halfway pressed and enters real shooting mode when the push button switch is fully pressed. A scene mode is set in order for an image pickup apparatus to automatically select, e.g., a shutter speed, an aperture value, and/or a subject advantageous to each of various shooting scenes and perform shooting under correct conditions. Examples of a scene mode include portrait mode, landscape mode, and close-up (macro) mode, and a camera operator can select a scene mode at the time of shooting.

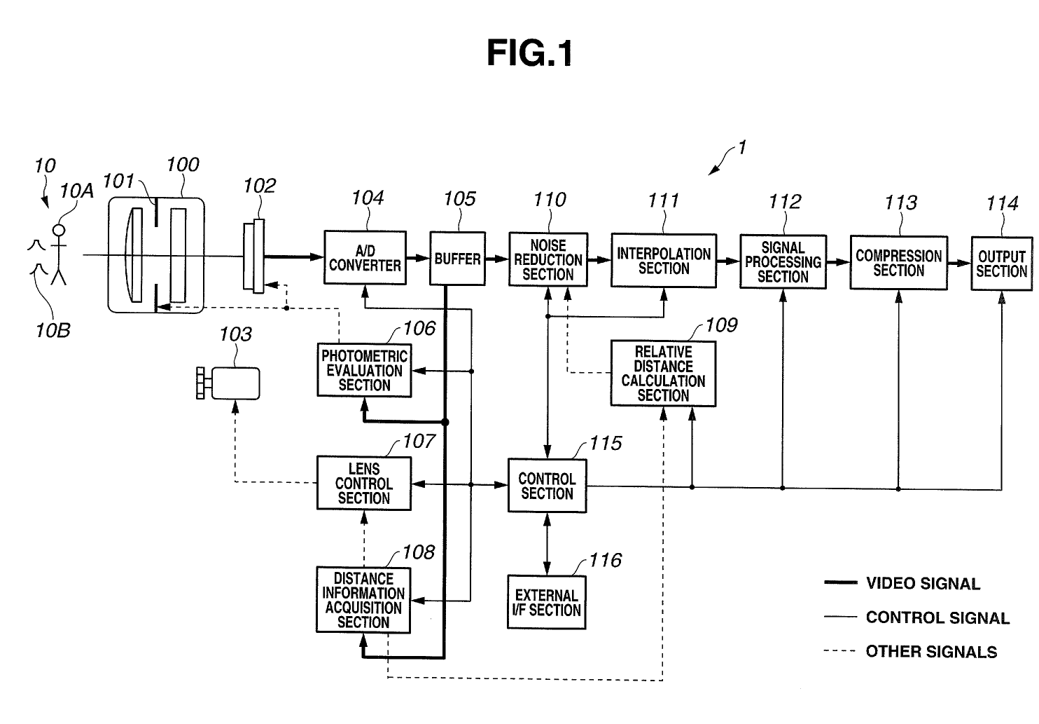

Next, a flow of signals in the image pickup apparatus 1 will be described with reference to FIG. 1. After shooting conditions such as an ISO sensitivity and a shutter speed are set through the external I/F section 116, the image pickup apparatus 1 enters the pre-shooting mode when the shutter button is halfway pressed. A video signal obtained from shooting by the CCD 102 through the lens system 100 and the diaphragm 101 is converted from an analog signal into a digital signal by the A/D converter 104 and is saved in the buffer 105. That is, a shooting step of shooting the subject 10 composed of the plurality of specific subjects 10A and 10B whose shooting distances from the CCD 102 are different and outputting video signals is performed by the image pickup section.

Note that, in the image pickup apparatus 1, the shooting step is performed again in the real shooting mode, as will be described later. In the image pickup apparatus 1, a process of reducing noise in a second video signal outputted in a second shooting step in the real shooting mode is performed on the basis of a first video signal outputted in a first shooting step in the pre-shooting mode. Of course, all processes may be performed using a video signal obtained from only one shooting step.

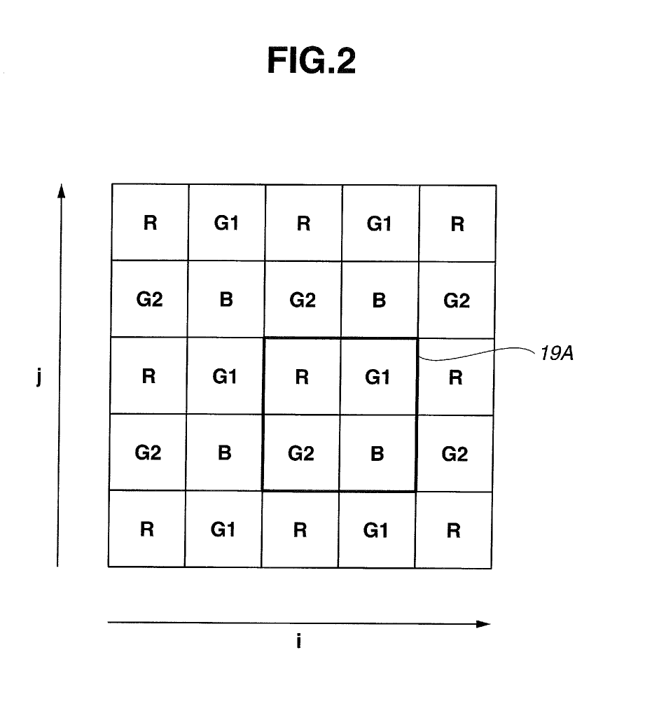

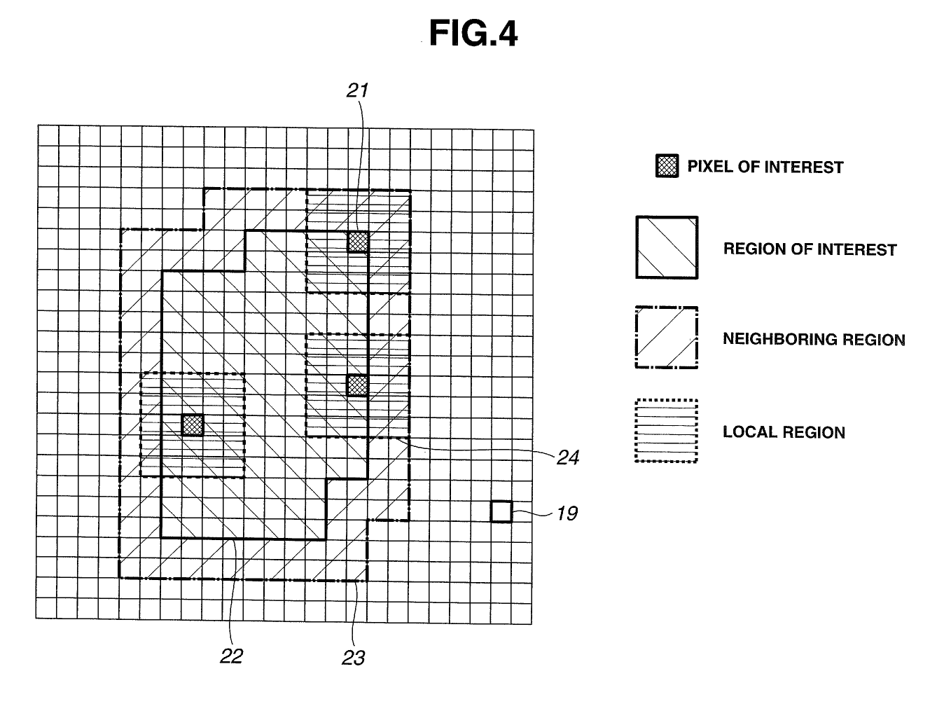

Note that the image pickup apparatus 1 according to the present embodiment will be described in the context of a single CCD having Bayer-pattern primary color filters as the CCD 102. FIG. 2 is an explanatory chart showing a configuration of Bayer-pattern primary color filters. The primary color filters have a structure in which a large number of CCD elements are two-dimensionally arranged. A lateral position (coordinate) of each CCD element is indicated by “i”, and a vertical position (coordinate) is indicated by “j”. A Bayer-pattern filter uses 2×2 pixels as a basic unit, and any one of four types of color filters, R, G1, G2, and B, is arranged for each element. Note that G1 and G2 are filters with same optical characteristics. Signals for pixels 19 (see FIG. 4), each composed of one video signal, are outputted in units of a basic unit 19A of 2×2 elements.

A video signal saved in the buffer 105 is transferred to the photometric evaluation section 106, the distance information acquisition section 108, and the noise reduction section 110. The photometric evaluation section 106 calculates a luminance level of the video signal and controls the diaphragm 101, an electronic shutter speed of the CCD 102, and the like to obtain correct exposure.

The distance information acquisition section 108 calculates a shooting distance d which is a distance from the image pickup apparatus 1 to the subject 10 for a video signal corresponding to each pixel. That is, a distance information acquisition step of calculating a shooting distance d between the subject 10 and the image pickup apparatus 1 corresponding to each video signal is performed. The distance information acquisition section 108 calculates an “out-focus parameter” indicating an “out of focus” state from, e.g., a plurality of images with different levels of defocus. The out-focus parameter here is an indicator of a defocus state of a luminance signal and is a parameter correlated with a variance of a PSF (Point Spread Function).

Since a relationship between a variance of a PSF and a shooting distance d is modeled by a predetermined relational expression, the distance information acquisition section 108 calculates, from the out-focus parameter, a shooting distance d from the image pickup apparatus 1 to the subject 10 for each of the pixels for video signals. Note that since the above-described relational expression varies according to conditions such as a lens configuration, a zoom setting, and an aperture, a shooting distance d is calculated using a relational expression corresponding to respective conditions.

As described above, the distance information acquisition section 108 calculates a shooting distance d for each of the pixels for video signals, i.e., calculates the same number of shooting distances d as the pixels of the CCD 102. Note that, alternatively, the image pickup apparatus 1 may divide video signals into a plurality of regions, calculate a shooting distance d for each of the divided regions, and create a distance map representing the shooting distances d, for improved processing efficiency. Pieces of information on the shooting distances d acquired by the distance information acquisition section 108 are transferred to the lens control section 107 and the relative distance calculation section 109.

The lens control section 107 serving as a specific distance acquisition section controls an AF motor 103 on the basis of pieces of shooting distance information obtained through the distance information acquisition section 108 and obtains a focused image focused on the one specific subject 10A (e.g., a person) on the basis of a set scene mode and the like. In other words, the lens control section 107 performs a specific distance information acquisition step of calculating distance information on a specific distance which is a focus distance at which a focused image can be obtained.

The relative distance calculation section 109 performs a relative distance calculation step of calculating relative distances r for all video signals corresponding to the respective pixels on the basis of the shooting distances d obtained from the distance information acquisition section 108 and a specific distance obtained by the lens control section 107.

The image pickup apparatus 1 then performs real shooting when the shutter button is fully pressed through the external I/F section 116. That is, the shooting step of shooting a subject by the image pickup section and outputting video signals is repeated again. A shooting step in the real shooting is a second shooting step of outputting a second video signal. A video signal to be subjected to noise reduction processing in a noise reduction step is the second video signal. A video signal obtained from shooting by the CCD 102 is transferred to the buffer 105, as in the pre-shooting mode, and is temporarily saved in the buffer 105. The real shooting is performed on the basis of exposure conditions obtained by the photometric evaluation section 106, focusing conditions obtained by the lens control section 107, and the like, and the shooting conditions are transferred to the control section 115.

The noise reduction section 110 of the image pickup apparatus 1 performs the noise reduction step of performing adaptive noise reduction processing on a video signal obtained from the buffer 105 on the basis of a relative distance r obtained from the relative distance calculation section 109. Note that the term adaptive means that a video signal for each pixel is subjected to processing appropriate to circumstances.

A video signal after the noise reduction processing is transferred to the interpolation section 111. The interpolation section 111 generates a video signal in a three state by known interpolation processing and transfers the video signal to the signal processing section 112. The signal processing section 112 performs known color conversion processing and gradation conversion processing on the video signal and transfers the video signal to the compression section 113. The compression section 113 performs known compression processing into, e.g., JPEG format and transfers the video signal to the output section 114. The output section 114 records and saves the video signal after the compression in a medium such as a memory card.

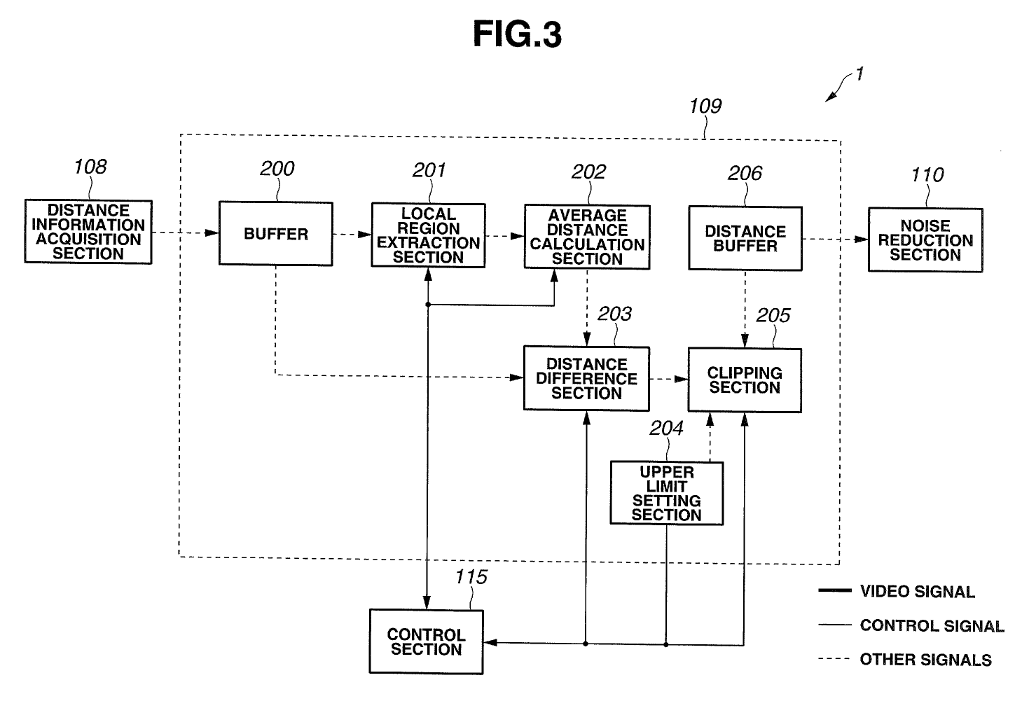

A configuration of the relative distance calculation section 109 will be described with reference to FIG. 3. As shown in FIG. 3, the relative distance calculation section 109 includes a buffer 200, a local region extraction section 201, an average distance calculation section 202, a distance difference section 203, an upper limit setting section 204, a clipping section 205, and a distance buffer 206. The distance information acquisition section 108 is connected to the buffer 200. The buffer 200 is connected to the local region extraction section 201 and the distance difference section 203. The local region extraction section 201 is connected to the average distance calculation section 202. The average distance calculation section 202 is connected to the distance difference section 203. The distance difference section 203 is connected to the clipping section 205. The upper limit setting section 204 is connected to the clipping section 205. The clipping section 205 is connected to the distance buffer 206, and the distance buffer 206 is connected to the noise reduction section 110. The control section 115 is bi-directionally connected to the local region extraction section 201, the average distance calculation section 202, the distance difference section 203, the upper limit setting section 204, and the clipping section 205.

Pieces of shooting distance information for the respective pixels which are transferred from the distance information acquisition section 108 are transferred to the buffer 200. The pieces of shooting distance information in the buffer 200 are transferred to the local region extraction section 201 and the distance difference section 203.

FIG. 4 is an explanatory chart for explaining a video image. The local region extraction section 201 shown in FIG. 3 extracts a local region 24 of a predetermined size (e.g., 3×3 pixels) centered on a certain pixel 21 of interest and acquires pieces of shooting distance information corresponding to video signals for pixels in the local region.

The pixel 21 of interest is one of the pixels 19 which serve as objects to be subjected to noise reduction processing and constitutes a part of a region 22 of interest. The local region 24 is a region centered on the pixel 21 of interest. As shown in FIG. 4, a neighboring region 23 is a region along an outer edge of the region 22 of interest which has a width of “(the number of pixels in a width of the local region 24 minus 1) divided by 2” pixels. In other words, the neighboring region 23 is a region of out-of-focus pixels within N pixels from pixels of interest. For example, N is an integer not less than 1 and is, e.g., 2 to 5. If N falls within the range, effects are achieved, and time needed for the image pickup apparatus 1 to perform correction processing poses no practical problem. Note that although FIG. 4 shows a part 20A of a video image 20 including the one region 22 of interest, the video image 20 includes a plurality of regions 22 of interest, and the processing described below is performed for each of the plurality of pixels of interest.

Pieces of shooting distance information in a local region are transferred to the average distance calculation section 202. The average distance calculation section 202 calculates an average value of the pieces of shooting distance information in the local region and transfers the average value to the distance difference section 203. The distance difference section 203 calculates a relative distance r which is an absolute value of a difference between the average value of the pieces of shooting distance information and a focus distance obtained through the buffer 200 and transfers the relative distance r to the clipping section 205.

The clipping section 205 executes a clipping step of performing clipping processing on a relative distance r transferred from the distance difference section 203 on the basis of a relative distance upper limit value maxr determined in advance by the upper limit setting section 204 in an upper limit setting step. The clipping processing here refers to a process of replacing a relative distance r above the relative distance upper limit value maxr determined in advance with the relative distance upper limit value maxr. The relative distance upper limit value maxr is provided in order to prevent a relative distance r from reaching an infinite value to cause difficulty in processing. The image pickup apparatus 1 can perform control so as to prevent excessive noise reduction processing by setting the relative distance upper limit value maxr. For example, a camera operator manually inputs the relative distance upper limit value maxr from the external I/F section 116 through the control section 115.

A piece of information on a relative distance r after the clipping processing is transferred to the distance buffer 206. After the clipping processing on all pixels, pieces of information on relative distances r saved in the distance buffer 206 are transferred to the noise reduction section 110. Note that although an average value of shooting distances d is calculated for each unit pixel in the above-described example, the present invention is not limited thereto. For example, if an average distance of shooting distances is obtained for each of small regions of a predetermined pixel unit size, an average value of average distances may be similarly calculated for each small region on the basis of pieces of information of neighboring small regions.

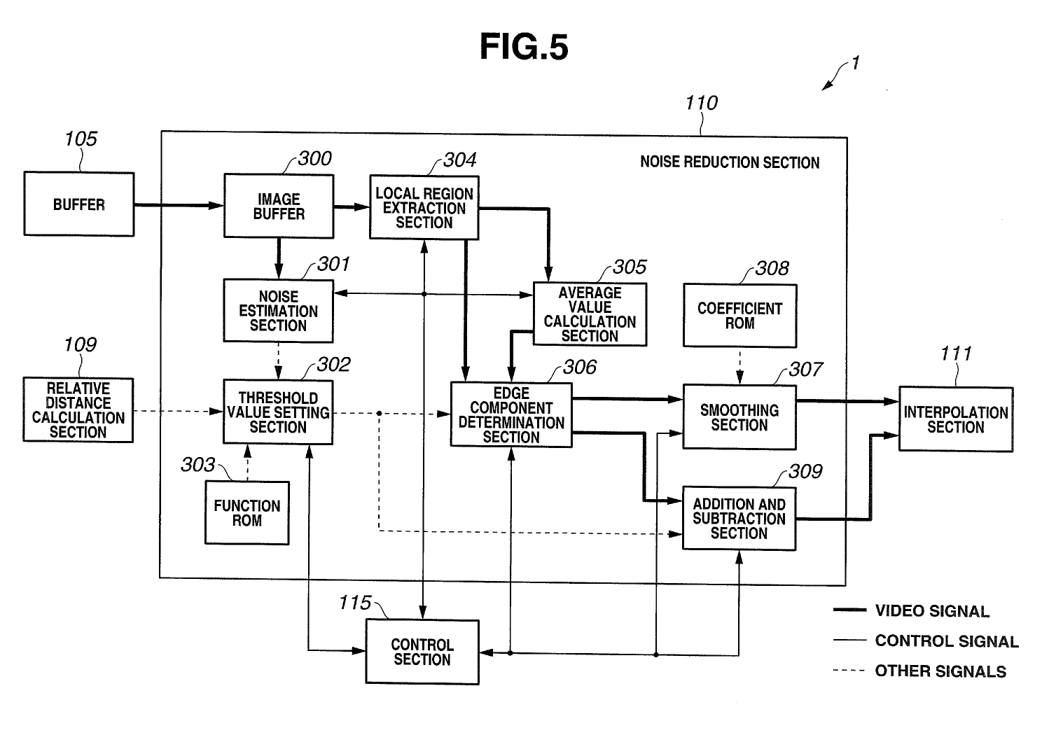

A configuration of the noise reduction section 110 will be described with reference to FIG. 5. As shown in FIG. 5, the noise reduction section 110 includes an image buffer 300, a noise estimation section 301, a threshold value setting section 302, a function ROM 303 serving as a function recording section which is a part of the threshold value setting section 302, a local region extraction section 304, an average value calculation section 305, an edge component determination section 306 which determines whether a target video signal is an edge component in coring processing, a smoothing section 307, a coefficient ROM 308 serving as a filter coefficient recording section, and an addition and subtraction section 309. The buffer 105 is connected to the image buffer 300. The image buffer 300 is connected to the noise estimation section 301 and the local region extraction section 304. The noise estimation section 301 is connected to the threshold value setting section 302 serving as a function operation section. The threshold value setting section 302 is connected to the edge component determination section 306 and the addition and subtraction section 309. The relative distance calculation section 109 and the function ROM 303 are connected to the threshold value setting section 302. The local region extraction section 304 is connected to the average value calculation section 305 and the edge component determination section 306. The average value calculation section 305 is connected to the edge component determination section 306. The edge component determination section 306 is connected to the smoothing section 307 and the addition and subtraction section 309. The coring processing is performed using the edge component determination section 306, the smoothing section 307, and the addition and subtraction section 309. The coefficient ROM 308 is connected to the smoothing section 307. The smoothing section 307 and the addition and subtraction section 309 are connected to the interpolation section 111. The control section 115 is bi-directionally connected to the noise estimation section 301, the threshold value setting section 302, the local region extraction section 304, the average value calculation section 305, the edge component determination section 306, the smoothing section 307, and the addition and subtraction section 309.

Video signals transferred from the buffer 105 are temporarily saved in the image buffer 300 and are transferred to the noise estimation section 301 and the local region extraction section 304. The noise estimation section 301 estimates a noise amount N(i,j) corresponding to a video signal for each pixel (i,j), i.e., any one of R, G, and B video signals corresponding to the pixel (i,j) using a noise function designed on the basis of pieces of shooting information such as an ISO sensitivity transferred from the control section 115 through the external I/F section 116. Note that (i,j) indicates coordinates of the pixel.

Estimation of a noise amount N is performed for each of color components, R, G1, G2, and B. A known method (e.g., the method disclosed in Japanese Patent Application Laid-Open Publication No. 2004-72422) can be used as a method for estimating the noise amount N. Note that calculation of the noise amount N to be estimated by the noise estimation section 301 is not limited to calculation for each pixel. The noise amount N may also be calculated for each of small regions such as a unit of 2×2 or 4×4 pixels.

Noise amounts N estimated by the noise estimation section 301 are transferred to the threshold value setting section 302. The threshold value setting section 302 reads out a predetermined function from the function ROM 303, on which a coefficient of a threshold value calculation function for calculating a coring threshold value is recorded, and calculates a coring threshold value th(i,j) for determining whether an inputted video signal is a noise component on the basis of a noise amount N(i,j) and a relative distance r(i,j) obtained by the relative distance calculation section 109, in a function recording step. More specifically, the threshold value setting section 302 sets the estimated noise amount N(i,j) as an initial value of the coring threshold value th(i,j) and corrects the coring threshold value th(i,j) on the basis of magnitude of the relative distance r(i,j) described above.

The image pickup apparatus 1 according to the present embodiment assumes that a region at a focus position is, e.g., a main region where a specific subject desired to be shot by a camera operator is shot and performs noise reduction processing on the main region while preventing degradation in original video signals to the utmost. For the reason, the image pickup apparatus 1 calculates a coring threshold value th which is a threshold value used in a coring step by, e.g., a threshold value calculation function given by expression 1 below in a coring threshold value setting step.

$$\{ \begin{matrix}{th}_{i , j} = \frac{{N}_{i , j} - {a}_{i , j}}{max r} \times {r}_{i , j} + {a}_{i , j} & ( {r}_{i , j} ≦ max r ) \\ {th}_{i , j} = {N}_{i , j} & ( {r}_{i , j} > max r )\end{matrix} \qquad ( expression 1 )$$

In expression 1, a(i,j) is a constant term representing a coring threshold value th when the relative distance r(i,j)=0 and is an arbitrary value from 0 to N(i,j). The parameter maxr is a constant term representing an upper limit value of a relative distances r and is obtained from the external I/F section 116 through the control section 115. The constant term a(i,j) is recorded on the function ROM 303. In expression 1, the coring threshold value th(i,j) is calculated by the upper expression if the relative distance r(i,j) is not more than maxr, and the coring threshold value th(i,j) is set to the noise amount N(i,j) as given by the lower expression if the relative distance r(i,j) is more than maxr.

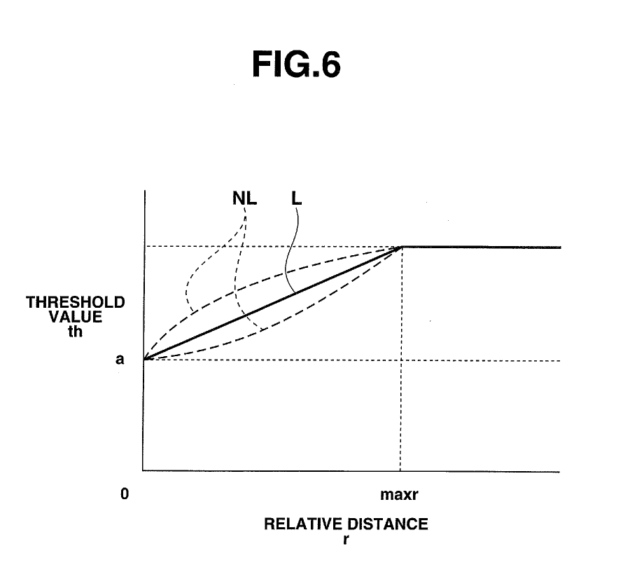

FIG. 6 is a plot showing a shape of a threshold value calculation function. In FIG. 6, L indicates a linear increasing function, and NL indicates examples of a nonlinear increasing function. The threshold value calculation function of expression 1 indicated by L in FIG. 6 is a linear increasing function, where a coring threshold value th increases linearly with respect to the relative distance r(i,j) if the relative distance r(i,j) is not more than maxr.

Note that the threshold value calculation function is not limited to a linear increasing function and that nonlinear increasing functions indicated by NL in FIG. 6, where a coring threshold value th increases nonlinearly with respect to the relative distance r(i,j), may be used instead. For example, as a threshold value calculation function, a nonlinearly formulated one is given by expression 2 below.

$$\{ \begin{matrix}{th}_{i , j} = {k}_{i , j} \times {( {r}_{i , j} - max r )}^{2} + {N}_{i , j} & ( {r}_{i , j} ≦ max r ) \\ {th}_{i , j} = {N}_{i , j} & ( {r}_{i , j} > max r )\end{matrix} \qquad ( expression 2 )$$

In expression 2, k(i,j) is a coefficient which determines a slope of a quadratic function. A value of k(i,j) is determined such that a value of the coring threshold value th(i,j) is a(i,j) if the relative distance r(i,j) is 0.

The function operation section, as which the threshold value setting section 302 serves, is easy to implement, and a low-cost system can be constructed. That is, the image pickup apparatus 1 uses a function to set a coring threshold value th and thus can achieve memory reduction and lower cost. Also, since the image pickup apparatus 1 has a function operation step of setting the coring threshold value th in consideration of not only a noise amount N but also a relative distance r, the image pickup apparatus 1 is capable of performing appropriate noise reduction processing on each of a plurality of different subject regions and obtaining high-quality video signals. Additionally, since the image pickup apparatus 1 uses an increasing function easy to implement as a threshold value calculation function, a low-cost image pickup apparatus can be provided.

The coring threshold value th(i,j) calculated by the threshold value setting section 302 is transferred to the edge component determination section 306 and the addition and subtraction section 309. The local region extraction section 304 extracts a local region of a predetermined size centered on a pixel of interest (e.g., a local region of 5×5 pixels) and transfers video signals for pixels belonging to the local region to the average value calculation section 305 and the edge component determination section 306. The average value calculation section 305 calculates an average value Ave(i,j) of the video signals for the pixels in the local region, i.e., R signals, G signals, and B signals and transfers the calculated average value Ave(i,j) to the edge component determination section 306.

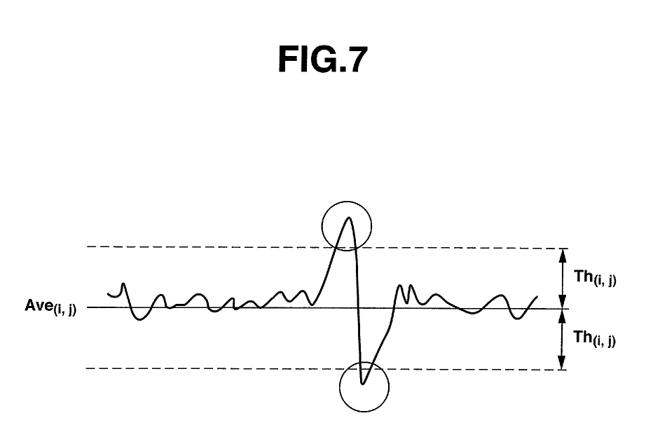

As shown in FIG. 7, the edge component determination section 306 determines whether a video signal for a pixel of interest obtained from the local region extraction section 304 is an edge component, on the basis of the average value Ave(i,j) obtained from the average value calculation section 305 and the coring threshold value th(i,j) obtained from the threshold value setting section 302. FIG. 7 is an explanatory graph showing a concept of edge component determination processing. In FIG. 7, the wavy line indicates an inputted video signal, the solid straight line indicates the average value Ave(i,j), and each dotted line indicates a border line representing a coring threshold value.

If an inputted video signal S(i,j) is smaller than a value obtained by adding the coring threshold value th(i,j) to the average value Ave(i,j) and is larger than a value obtained by subtracting the coring threshold value th(i,j) from the average value Ave(i,j), the edge component determination processing determines the video signal S(i,j) to be a noise component. On the other hand, if the inputted video signal S(i,j) is larger than the value obtained by adding the coring threshold value th(i,j) to the average value Ave(i,j) or smaller than the value obtained by subtracting the coring threshold value th(i,j) from the average value Ave(i,j), the edge component determination processing determines the video signal S(i,j) to be an edge component. If the edge component determination processing in the above description is expressed as an expression, the expression is given by expression 3 below.

$$\{ \begin{matrix}if ( {Avg}_{i , j} - {N}_{i , j} ) ≦ {S}_{i , j} ≦ ( {Avg}_{i , j} + {N}_{i , j} ) \\ then {S}_{i , j} is noise \\ if {(}_{i , j} - {N}_{i , j} ) > {S}_{i , j} or {S}_{i , j} < ( {Avg}_{i , j} + {N}_{i , j} ) \\ then {S}_{i , j} is edge\end{matrix} \qquad ( expression 3 )$$

For example, of video signals S shown in FIG. 7, circled ones are determined to be edge components by the edge component determination section 306. The edge component determination section 306 transfers video signals in a local region to the smoothing section 307 if the edge component determination section 306 determines a video signal for a pixel of interest to be a noise component and transfers the video signal for the pixel of interest to the addition and subtraction section 309 if the edge component determination section 306 determines the video signal for the pixel of interest to be an edge component.

The smoothing section 307 reads out a predetermined filter coefficient from the coefficient ROM 308 as the filter coefficient recording section, on which filter coefficients corresponding to filter sizes are recorded, in a filter coefficient recording step. The smoothing section 307 subjects a transferred video signal to a smoothing processing step of performing known smoothing processing using, e.g., a low-pass filter, based on video signals in a local region. After the smoothing processing step, the smoothing section 307 transfers a video signal for a pixel of interest after the smoothing to the interpolation section 111.

The addition and subtraction section 309 is a process provided to preserve continuity of video signals between a pixel of interest and a neighboring pixel. For example, in the addition and subtraction section 309, if the video signal S(i,j) for a pixel of interest is larger than Ave(i,j)+N(i,j), the noise amount N(i,j) is subtracted from the video signal S(i,j). If the video signal S(i,j) is smaller than Ave(i,j)−N(i,j), the noise amount N(i,j) is added to the video signal S(i,j). The video signal after the addition or subtraction is transferred to the interpolation section 111. Since the image pickup apparatus 1 performs smoothing processing on a video signal on the basis of a relative distance r to reduce noise components, high-quality video signals are obtained.

As described above, the image pickup apparatus 1 and a noise reduction method for a video signal according to the present embodiment can obtain high-quality video signals even from video signals obtained when a plurality of specific subjects at different shooting distances d are shot. The image pickup apparatus 1 and the noise reduction method for a video signal according to the present embodiment performs appropriate noise reduction processing on even video signals obtained when a plurality of specific subjects at short shooting distances d are shot and thus can obtain high-quality video signals.

The image pickup apparatus 1 according to the present embodiment further includes the specific distance acquisition section which acquires specific distance information from pieces of shooting distance information obtained from the distance measurement section on the basis of focus information, photometric information, and lens focal distance information of the image pickup section and the relative distance calculation section which calculates a relative distance r between each piece of shooting distance information associated with a video signal and the specific distance information, in addition to the above-described configuration. The control section controls noise reduction processing on the basis of a relative distance r. That is, the image pickup apparatus 1 includes the control section which calculates a relative distance r between a piece of distance information for each video signal and a focus distance and controls noise reduction processing on the video signal on the basis of the relative distance r. For the reason, the image pickup apparatus 1 obtains high-quality video signals by performing noise reduction processing appropriate to each video signal at a predetermined distance.

Since the noise reduction section of the image pickup apparatus 1 includes the smoothing section which performs smoothing processing on a video signal on the basis of a relative distance r associated with the video signal, the image pickup apparatus 1 reduces noise components by the smoothing processing and obtains high-quality signals.

The image pickup apparatus 1 becomes capable of performing optimum noise reduction processing not only on a per-pixel basis but also in units of predetermined number of pixels and can obtain high-quality video signals. Since the image pickup apparatus 1 sets a coring threshold value th on the basis of a relative distance r, the image pickup apparatus 1 becomes capable of obtaining a video signal with a less degraded edge component for a main region at a focus position.

The noise reduction section of the image pickup apparatus 1 further includes the noise estimation section which estimates a noise amount N included in a video signal on the basis of the video signal, the threshold value setting section which sets a coring threshold value th on the basis of a relative distance r and the noise amount N, and a coring section which performs coring processing on a video signal on the basis of the video signal and a coring threshold value th. For the reason, the image pickup apparatus 1 performs appropriate noise reduction processing on a video signal at a focus position by setting a coring threshold value th on the basis of the relative distance r together with the noise amount N. Accordingly, the image pickup apparatus 1 is capable of obtaining high-quality video signals.

That is, since the image pickup apparatus 1 does not regard edge components in video signals as noise components even if the noise amount is large, an original signal is not degraded by noise reduction processing. Noise reduction processing by the image pickup apparatus 1 is performed to suit a subject. For example, even if the noise amount in video signals of a subject with a fine texture is large, noise reduction processing does not prevent a structure of the fine texture of the subject from being displayed.

### First Modification of First Embodiment

An image pickup apparatus 1B according to a first modification of the first embodiment of the present invention will be described below with reference to the drawings. The image pickup apparatus 1B according to the present modification is similar to the image pickup apparatus 1 according to the first embodiment. Accordingly, same components are denoted by same reference numerals, and a description of the components will be omitted.

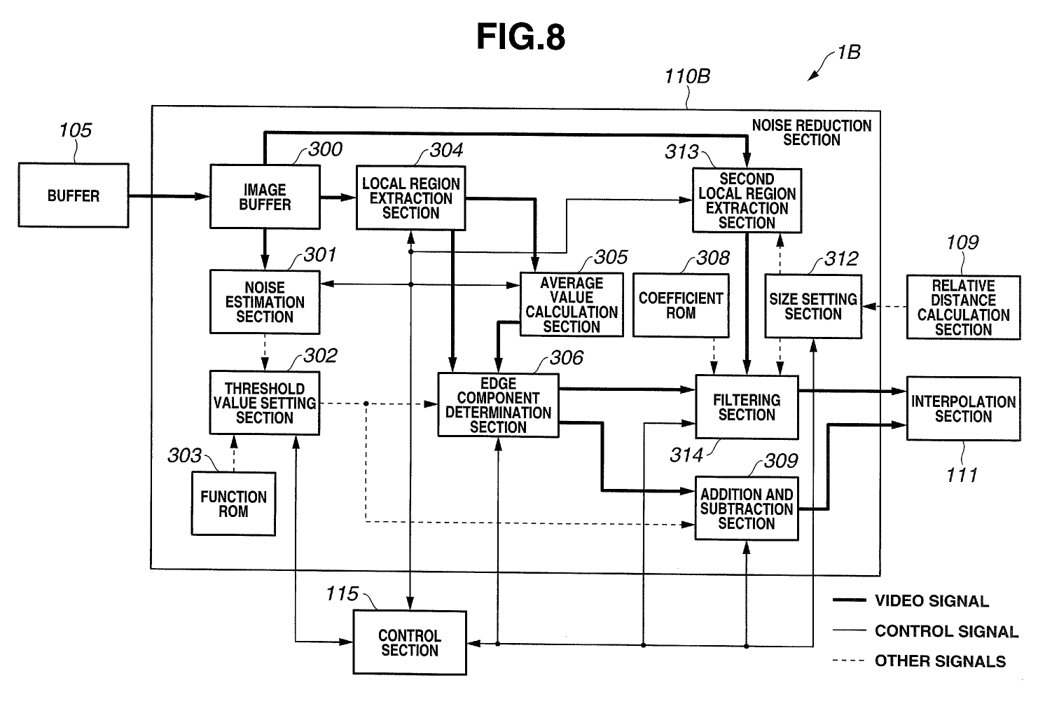

As shown in FIG. 8, a noise reduction section 110B of the image pickup apparatus 1B includes a size setting section 312, which has a smoothing function, serving as a filter size setting section which performs a size setting step, a second local region extraction section 313, and a filtering section 314 which performs a filtering step, all of which have a smoothing function.

In the noise reduction section 110B, the relative distance calculation section 109 is connected to the size setting section 312. The image buffer 300 and the size setting section 312 are connected to the second local region extraction section 313. The edge component determination section 306, the coefficient ROM 308, the size setting section 312, and the second local region extraction section 313 are connected to the filtering section 314. The filtering section 314 is connected to the interpolation section 111. The control section 115 is bi-directionally connected to the size setting section 312, the second local region extraction section 313, and the filtering section 314.

Pieces of information on relative distances r obtained from the relative distance calculation section 109 are transferred to the size setting section 312. The size setting section 312 performs the size setting step of selecting a size of a filter representing a position range from each of pixels for video signals from among, e.g., 1×1 pixel to 9×9 pixels and setting the filter size on the basis of a relative distance r for each of the pixels of the video signals. The filter has an action of a low-pass filter. As the filter size increases, filtering is performed on the basis of pieces of information of pixels within a wider range. The filter therefore reduces more high-frequency components of video signals. The image pickup apparatus 1B selects a small filter size if a relative distance r of a video signal for each pixel is short and selects a large filter size if the relative distance r is long. The image pickup apparatus 1B can change the level of noise reduction processing by changing a filter size on the basis of a relative distance r of each video signal and becomes capable of obtaining high-quality video signals.

The relative distance calculation section 109 is set to increase a filter size with an increase in a relative distance r in the above description. However, if a filter size is monotonically increased, the filter size may become extremely large. For the reason, the image pickup apparatus 1B sets an upper limit value for a filter size and performs low-pass filtering on a pixel at a relative distance r which is not less than a predetermined value using a filter of a size corresponding to the upper limit value.

Pieces of information on filter sizes set by the size setting section 312 are transferred to the second local region extraction section 313 and the filtering section 314. The second local region extraction section 313 extracts a local region of a filter size centered on a pixel of interest from video signals transferred from the image buffer 300 and transfers video signals for pixels in the local region to the filtering section 314.

The filtering section 314 reads out a filter coefficient corresponding to a filter size from the coefficient ROM 308 and performs low-pass filtering on a video signal for a pixel of interest determined to be a noise component by the edge component determination section 306 using video signals for pixels in a local region obtained from the second local region extraction section 313.

A video signal outputted from the filtering section 314 is transferred to the interpolation section 111. Note that although a filter size is set on the basis of a relative distance r in the above description, the present invention is not limited thereto. For example, a configuration in which a filter coefficient is set on the basis of a relative distance r without using a filter size as a parameter may be used instead.

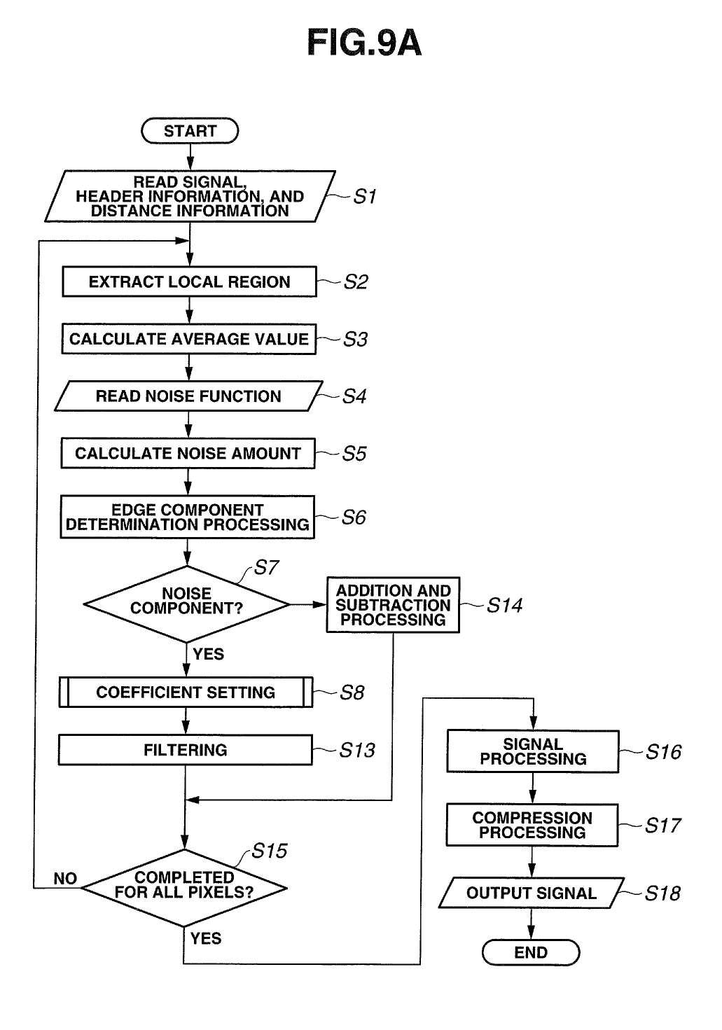

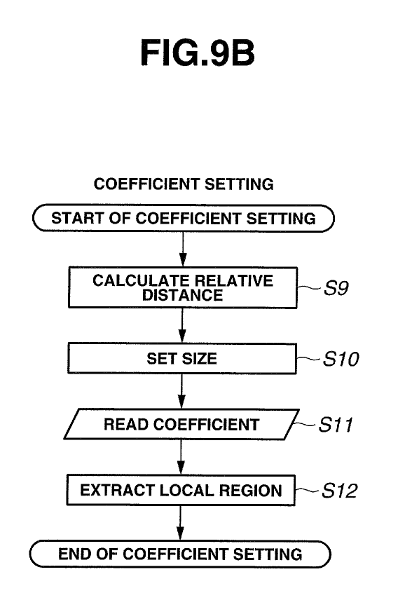

A flow of noise reduction processing in the image pickup apparatus 1B according to the present embodiment will be described here with reference to FIGS. 9A and 9B.

### <Step S1> Shooting Step

First, the CCD 102 serving as an image pickup section of the image pickup apparatus 1B shoots the subject 10 and outputs unprocessed video signals. The image pickup apparatus 1B reads the unprocessed video signals and header information including pieces of associated information on image pickup conditions, such as an ISO sensitivity, white balance coefficients, and a setting mode, and saves the unprocessed video signals and the header information in the image buffer 300 and the like.

### <Step S2>

The local region extraction section 304 extracts a local region of a size of, e.g., 3×3 pixels centered on a pixel of interest.

### <Step S3>

The average value calculation section 305 calculates an average value of video signals for pixels in the local region extracted in step S2.

### <Step S4>

The image pickup apparatus 1B reads a noise function from the function ROM 303 on the basis of the header information including the ISO sensitivity and the white balance coefficients read in step S1.

### <Step S5>

The noise estimation section 301 executes a noise estimation step of estimating a noise amount N according to the average value calculated in step S3 and the noise function read in step S4.

### <Step S6>

The edge component determination section 306 executes an edge component determination step of performing edge component determination processing for determining whether a video signal to be processed is an edge component using the noise amount N obtained in step S5 as a coring threshold value th with respect to the average value in step S3.

### <Step S7>

The edge component determination section 306 determines whether the video signal which has been subjected to the edge component determination processing in step S6 is a noise component or an edge component. If the video signal is a noise component, the flow restarts from the process in step S8. On the other hand, if the video signal is an edge component, the flow restarts from a process in step S14.

### <Step S8>

The image pickup apparatus 1B executes a filter coefficient setting step of setting a coefficient for filtering. More specifically, processes in steps S9 to S12 are performed.

### <Step S9>

The relative distance calculation section 109 calculates a relative distance r for the pixel of interest.

### <Step S10>

The size setting section 312 sets a filter size corresponding to magnitude of the relative distance r calculated in step S9.

### <Step S11>

The image pickup apparatus 1B reads a filter coefficient corresponding to the filter size set in step S10 from the coefficient ROM 308.

### <Step S12>

The second local region extraction section 313 extracts a local region of the filter size centered on the pixel of interest set in step S10.

### <Step S13>

The filtering section 314 performs low-pass filter processing serving as a filtering step on the basis of the filter coefficient read in step S11 and video signals in the local region extracted in step S12.

### <Step S14>

The addition and subtraction section 309 adds or subtracts the noise amount N estimated in step S5 to or from the video signal transferred from step S7.

### <Step S15>

The image pickup apparatus 1B determines whether processing on all pixels is completed. If the processing is not completed, the processes from step S2 are repeated until the processing on all the pixels is completed.

### <Step S16>

The signal processing section 112 performs known interpolation processing, color conversion, gradation conversion, edge enhancement processing, and the like.

### <Step S17>

The compression section 113 performs known compression processing into, e.g., JPEG format.

### <Step S18>

The output section 114 outputs video signals after the processing, and the whole processing ends.

As described above, a smoothing section of the image pickup apparatus 1B includes the size setting section which sets a filter size on the basis of a relative distance r, a recording section which records filter coefficients corresponding to filter sizes, and the filtering section which reads out a filter coefficient from the recording section on the basis of a filter size and performs low-pass filtering on a video signal. That is, the image pickup apparatus 1B sets a filter size corresponding to a relative distance r by the size setting section 312, reads out a filter coefficient from the coefficient ROM 308, and performs filtering on a video signal for a pixel of interest by the filtering section 314 on the basis of the filter coefficient.

In addition to the effects of the image pickup apparatus 1 or the like, the image pickup apparatus 1B is advantageous in that the level of noise reduction processing can be changed by changing a filter size with respect to a relative distance r. The image pickup apparatus 1B thus can obtain higher-quality video signals.

### Second Modification of First Embodiment

An image pickup apparatus 1C according to a second modification of the first embodiment of the present invention will be described below with reference to the drawing. The image pickup apparatus 1C according to the present modification is similar to the image pickup apparatus 1B according to the first modification of the first embodiment. Accordingly, same components are denoted by same reference numerals, and a description of the components will be omitted.

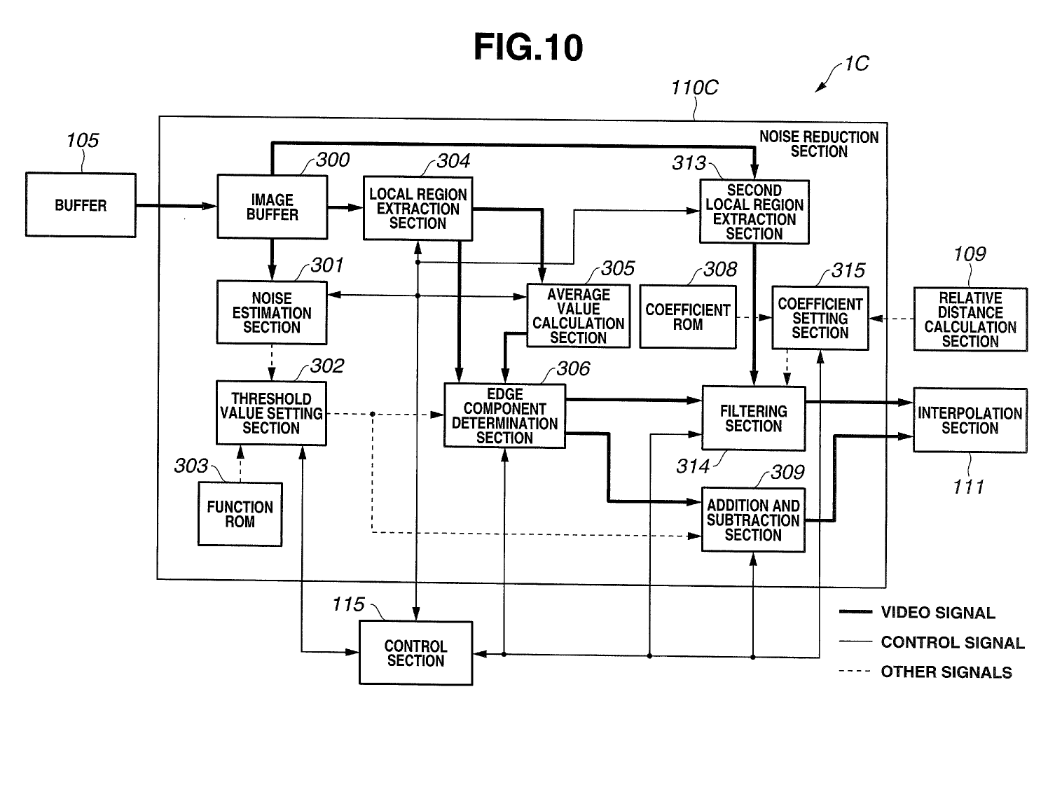

As shown in FIG. 10, a noise reduction section 110C of the image pickup apparatus 1C has a configuration obtained by removing the size setting section 312 from the configuration of the noise reduction section 110B and adding a coefficient setting section 315 serving as a filter coefficient setting section to the noise reduction section 110B.

In the noise reduction section 110C of the image pickup apparatus 1C, the relative distance calculation section 109 and the coefficient ROM 308 are connected to the coefficient setting section 315. The coefficient setting section 315 is connected to the filtering section 314. The control section 115 is bi-directionally connected to the coefficient setting section 315.

The coefficient setting section 315 sets a filter coefficient on the basis of a value of a relative distance r transferred from the relative distance calculation section 109. A predetermined low-pass filter coefficient is recorded in advance on the coefficient ROM 308. The coefficient setting section 315 performs filtering with reduced degradation in video signals by, e.g., setting a coefficient for a pixel of interest again to be larger than a coefficient for a neighboring pixel of the pixel of interest if the relative distance r is smaller than a predetermined value. A neighboring pixel of the pixel of interest here refers to a pixel within a predetermined number of pixels from the pixel of interest, neighbors the pixel of interest and is within N pixels (N is an integer not less than 1) from the pixel of interest. For example, if N=1, a neighboring pixel is a pixel in a region of 3×3 pixels centered on the pixel of interest. If N=2, a neighboring pixel is a pixel in a region of 5×5 pixels centered on the pixel of interest. If N=4, a neighboring pixel is a pixel in a region of 9×9 pixels centered on the pixel of interest.

The image pickup apparatus 1C is capable of adaptively changing the level of filtering by setting filter coefficients for a pixel of interest and a neighboring pixel of the pixel of interest again. If the relative distance r is larger than the predetermined value, the coefficient setting section 315 sets the coefficients for the pixel of interest and the neighboring pixel again to be equal such that high-level filtering is to be performed. Note that a method for changing the level of filtering in the image pickup apparatus 1C is not limited to the process of changing set filter coefficients and that a process of adaptively changing a standard deviation of a Gaussian distribution representing weight in a bilateral filter on the basis of a relative distance r may be used.

A smoothing section of the image pickup apparatus 1C includes the filter coefficient setting section which sets a filter coefficient on the basis of a relative distance r and the filtering section which performs low-pass filtering on a video signal on the basis of the filter coefficient. For the reason, the image pickup apparatus 1C is capable of changing the level of noise reduction processing on each of specific regions whose relative distances r are different by changing a filter coefficient for each relative distance r. In addition to the effects of the image pickup apparatus 1 and the like, the image pickup apparatus 1C is advantageous in that higher-quality video signals can be obtained.

That is, the image pickup apparatus 1C becomes capable of higher-accuracy smoothing processing by changing a filter coefficient and a filter size on the basis of each relative distance r and can obtain high-quality video signals without degrading original video signals.

### Third Modification of First Embodiment

An image pickup apparatus 1D according to a third modification of the first embodiment of the present invention will be described below with reference to the drawing. The image pickup apparatus 1D according to the present modification is similar to the image pickup apparatus 1 according to the first embodiment. Same components are denoted by same reference numerals, and a description of the components will be omitted.

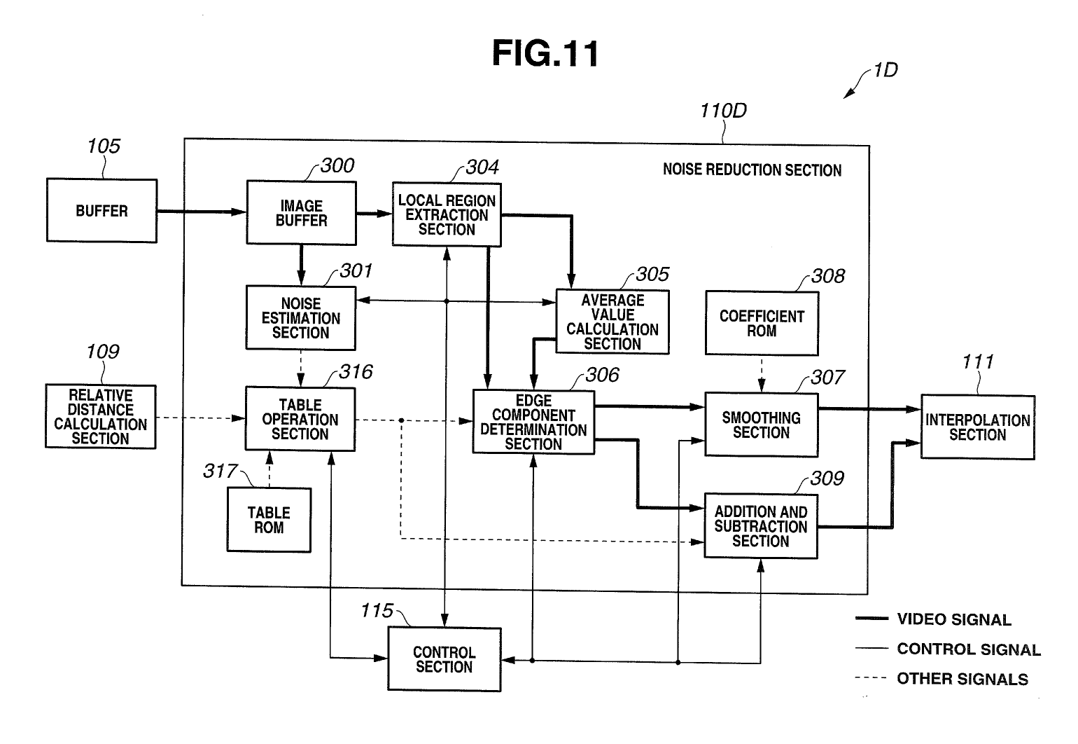

As shown in FIG. 11, a noise reduction section 110D of the image pickup apparatus 1D has a configuration obtained by removing the threshold value setting section 302 and the function ROM 303 from the noise reduction section 110 shown in FIG. 5 and adding a table operation section 316 having a threshold value setting function and a table ROM 317 serving as a table recording section to the noise reduction section 110. That is, the noise reduction section 110D is configured to have a table operation step of obtaining a coring threshold value th while referring to the table recording section on which a table (correspondence table) of a correspondence among a noise amount N, a relative distance r, and a coring threshold value th is recorded in advance in a table recording step, instead of calculating a coring threshold value th using a function.

In the noise reduction section 110D of the image pickup apparatus 1D, the relative distance calculation section 109 and the noise estimation section 301 are connected to the table operation section 316. The table ROM 317 is connected to the table operation section 316. The table operation section 316 is connected to the edge component determination section 306 and the addition and subtraction section 309. A piece of information on a relative distance r obtained by the relative distance calculation section 109 and a noise amount N for a video signal estimated by the noise estimation section 301 are transferred to the table operation section 316. The table operation section 316 calculates a coring threshold value th while referring to the table ROM 317, on which a correspondence among a relative distance r, a noise amount N, and a coring threshold value th is recorded.

Assume here that the coring threshold value table recorded on the table ROM 317 is defined in advance. The table is obtained by, e.g., previously sampling a relative distance r at regular intervals using the threshold value calculation function shown in FIG. 6 and calculating a coring threshold value th corresponding to each relative distance r obtained by the sampling and a noise amount N. A coring threshold value th calculated by the table operation section 316 is transferred to the edge component determination section 306 and the addition and subtraction section 309. Processing subsequent to the transfer is equivalent to processing by the noise reduction section 110 shown in FIG. 5, and a description of the processing will be omitted.

As described above, the image pickup apparatus 1D is an image pickup apparatus including the table operation section 316, which calculates a coring threshold value th corresponding to a relative distance r and a noise amount N while referring to the table ROM 317. Since the table operation section is easy to implement, the image pickup apparatus 1D is advantageous in high speed and low cost, in addition to the effects of the image pickup apparatus 1 and the like.

Note that although a single CCD in which Bayer-pattern primary color filters are arranged on a front is used as a CCD of the image pickup apparatus 1 or the like in the above description of the image pickup apparatus 1 or the like, the present invention is not limited to the CCD. A single CCD in which a complementary color filter is arranged on a front or 3 CCD may also be used. For example, if a single CCD of a complementary color is used as a CCD of an image pickup apparatus, luminance and color-difference signals are calculated from Cy, Mg, Ye, and G signals by a predetermined calculation formula, and the noise amount N included in each signal is estimated.

In the image pickup apparatus 1 or the like, although a simple average value of video signals for pixels in a predetermined local region is used as a video signal used at the time of estimation of a noise amount N and edge component determination processing in the above description, the present invention is not limited to the average value. Weighted average value, a median value, or the like may be used. A method using an output obtained by edge-preserving filtering using a bilateral filter or the like may also be used to estimate a noise amount N.

Although the image pickup apparatus 1 or the like is premised on hardware processing in the above description, the present invention need not be limited to such a configuration based on hardware processing. For example, a configuration in which a video signal from the CCD 102 is unprocessed raw data, and information at the time of shooting from the control section 115 is outputted as header information and is separately processed by software is also possible.

### Second Embodiment

An image pickup apparatus 1E according to a second embodiment of the present invention will be described below with reference to the drawing. The image pickup apparatus 1E according to the present embodiment is similar to the image pickup apparatus 1 according to the first embodiment. Accordingly, same components are denoted by same reference numerals, and a description of the components will be omitted.

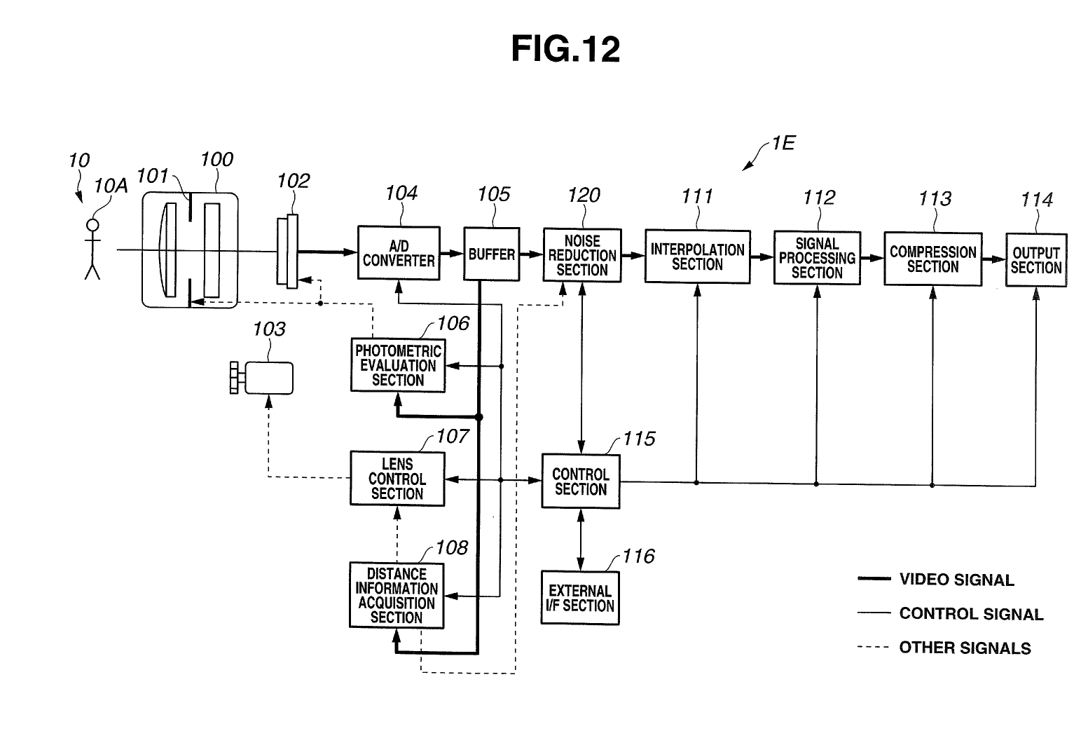

As shown in FIG. 12, a configuration of the image pickup apparatus 1E according to the present embodiment is obtained by removing the relative distance calculation section 109 and the noise reduction section 110 from the image pickup apparatus 1 according to the first embodiment and adding a noise reduction section 120 to the image pickup apparatus 1.

In the image pickup apparatus 1E, a distance information acquisition section 108 is connected to the noise reduction section 120. The noise reduction section 120 is connected to an interpolation section 111. A control section 115 is bi-directionally connected to the noise reduction section 120.

A flow of signals in the image pickup apparatus 1E will be described below with reference to FIG. 12. Shooting distance information transferred from the distance information acquisition section 108 is transferred to the noise reduction section 120. The noise reduction section 120 extracts pieces of shooting distance information for a pixel of interest and a neighboring pixel of the pixel of interest on the basis of the shooting distance information obtained from the distance information acquisition section 108 and performs adaptive noise reduction processing on video signals on the basis of shooting distances d for the extracted pixels. The video signals after the noise reduction processing are transferred to the interpolation section 111. Subsequent operation of the image pickup apparatus 1E is the same as that of the image pickup apparatus 1 according to the first embodiment.

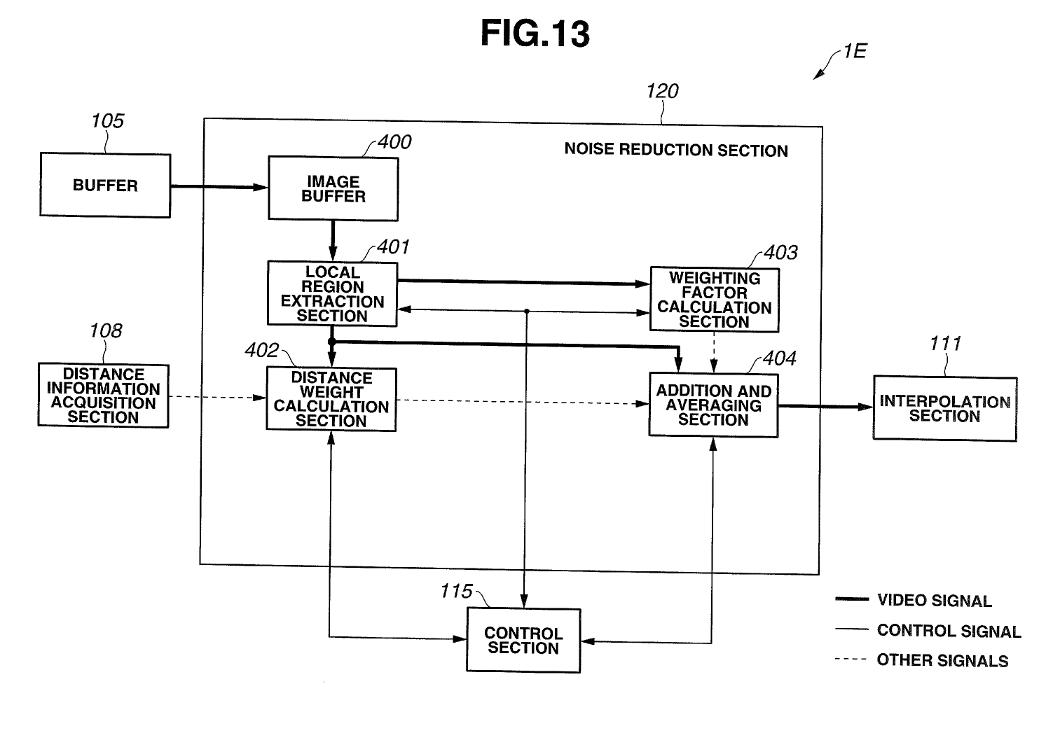

A configuration of the noise reduction section 120 of the image pickup apparatus 1E will be described with reference to FIG. 13. As shown in FIG. 13, the noise reduction section 120 includes an image buffer 400, a local region extraction section 401, a distance weight calculation section 402, a distance weighting factor calculation section (hereinafter also referred to as a “weighting factor calculation section”) 403, and an addition and averaging section 404. A buffer 105 is connected to the image buffer 400. The distance information acquisition section 108 is connected to the distance weight calculation section 402. The image buffer 400 is connected to the local region extraction section 401. The local region extraction section 401 is connected to the distance weight calculation section 402, the weighting factor calculation section 403, and the addition and averaging section 404. The distance weight calculation section 402 and the weighting factor calculation section 403 are connected to the addition and averaging section 404. The addition and averaging section 404 is connected to the interpolation section 111. The control section 115 is bi-directionally connected to the local region extraction section 401, the distance weight calculation section 402, the weighting factor calculation section 403, and the addition and averaging section 404.

A flow of signals in the noise reduction section 120 will be described below with reference to FIG. 13. Video signals transferred from the buffer 105 are transferred to and are temporarily saved in the image buffer 400. The video signals saved in the image buffer 400 are transferred to the local region extraction section 401. The local region extraction section 401 extracts a local region of a predetermined size centered on a pixel of interest (e.g., a size of 5×5 pixels) and transfers video signals for pixels in the local region to the distance weight calculation section 402, the weighting factor calculation section 403, and the addition and averaging section 404, respectively.

The weighting factor calculation section 403 calculates a first weighting factor w1 on the basis of a difference between video signals for a pixel of interest and a neighboring pixel of the pixel of interest and a distance between the two pixels, i.e., a difference between coordinate values, as in a known bilateral filter. The distance weight calculation section 402 calculates a shooting distance difference which is a difference between a shooting distance d associated with the pixel of interest and a shooting distance d associated with a neighboring pixel including the pixel of interest and calculates a second weighting factor for each of pixels in a local region. If processing by the weighting factor calculation section 403 is expressed as an expression, the expression is given by expression 4 below.

$$w ( i + m , j + n ) = \frac{exp ( - \frac{{( d ( i , j ) - d ( i + m , j + n ) )}^{2}}{2 {σ}_{d}^{2}} )}{{\sum }_{n = - w}^{w} {\sum }_{m = - w}^{w} exp ( - \frac{{( \begin{matrix}d ( i , j ) - \\ d ( i + m , j + n )\end{matrix} )}^{2}}{2 {σ}_{d}^{2}} )} \qquad ( expression 4 )$$

In expression 4, (i,j) indicates coordinates of a pixel of interest, (i+m,j+n) indicates coordinates of a neighboring pixel which is m pixels apart from the pixel of interest (i,j) in a horizontal direction and is n pixels apart from the pixel of interest (i,j) in a vertical direction, and w(i+m,j+n) indicates a second weighting factor w2 based on a shooting distance d for a pixel with coordinates (i+m,j+n). The parameter d(i,j) represents a shooting distance d for the pixel with the coordinates (i,j), and σd is a coefficient indicating a standard deviation of a Gaussian distribution representing weight with respect to a shooting distance.

That is, in expression 4, a second weighting factor w2 for a neighboring pixel decreases with an increase in a difference between a shooting distance d for a pixel of interest and a shooting distance d for the neighboring pixel. However, if any one of the shooting distance d for the pixel of interest and the shooting distance d of the neighboring pixel is infinity, the weighting factor calculation section 403 cannot perform the calculation in expression 4. For the reason, the weighting factor calculation section 403 defines an upper limit value for a shooting distance difference in advance and replaces a shooting distance difference with the upper limit value if the shooting distance difference is above the upper limit value. The upper limit value for a shooting distance difference is preferably changed according to the type of a subject. For example, if a distance difference is small for a whole region (e.g., at the time of macro photography), the upper limit value for a shooting distance difference is set to be small. If a landscape is to be shot, a shooting distance difference between regions in video signals is expected to be large, and the upper limit value for a shooting distance difference is set to be large accordingly.

Setting of the upper limit value for a shooting distance difference is implemented by transferring the upper limit value to the weighting factor calculation section 403 through the control section 115 on the basis of a scene mode set by the external I/F section 116.

A second weighting factor w2 calculated by the weighting factor calculation section 403 is transferred to the addition and averaging section 404. The addition and averaging section 404 calculates a weighted addition average value of video signals in a local region on the basis of a first weighting factor w1 calculated by the weighting factor calculation section 403 and a second weighting factor w2 calculated by the distance weight calculation section 402. In the image pickup apparatus 1E, a weighted addition average value of video signals calculated by the addition and averaging section 404 is replaced with a video signal for a pixel of interest.

Use of a difference in shooting distance between a pixel of interest and a neighboring pixel as a weighting factor at the time of addition average value calculation in the image pickup apparatus 1E makes it possible to hold an edge component between regions with a shooting distance difference and perform high-accuracy noise reduction processing on a video signal other than an edge component. Since a weighting factor with a high addition ratio is given to a pixel in a region with a short shooting distance d in the image pickup apparatus 1E, high-accuracy smoothing processing using information on pixels in a region which has a short shooting distance d and is thought of as an identical specific subject can be performed. Even if there is a fine edge component with a small difference between video signals for pixels, the image pickup apparatus 1E is capable of high-accuracy noise reduction processing with edge components held using shooting distance information.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A noise reduction method for a video signal, comprising:
a shooting step of shooting a subject by an image pickup section and outputting the video signal;
a distance information acquisition step of calculating a shooting distance between the subject and the image pickup section corresponding to the video signal;
a specific distance information acquisition step of calculating a specific distance which is a shooting distance between one subject of the subject and the image pickup section on the basis of focus information of the one subject;
a relative distance calculation step of calculating a relative distance corresponding to the video signal on the basis of the shooting distance and the specific distance; and
a noise reduction step of performing noise reduction processing on the video signal on the basis of the relative distance, the noise reduction step including a smoothing step of performing smoothing processing on the video signal on the basis of the relative distance.

2. The noise reduction method for the video signal according to claim 1, wherein
the noise reduction step includes
a noise estimation step of estimating a noise amount included in the video signal,
a coring threshold value setting step of setting a coring threshold value which is a threshold value used in coring processing on the basis of the relative distance and the estimated noise amount, and
a coring step of performing the coring processing on the video signal using the coring threshold value.

3. The noise reduction method for the video signal according to claim 2, wherein
the smoothing step includes
a size setting step of setting a filter size indicating a position range from a predetermined center pixel such that the filter size monotonically increases with an increase in the relative distance,
a filter coefficient recording step of recording a filter coefficient corresponding to the filter size, and
a filtering step of reading out the filter coefficient from a filter coefficient recording section on the basis of the filter size and performing low-pass filtering on the video signal.

4. The noise reduction method for the video signal according to claim 3, wherein
the coring threshold value setting step includes
a function recording step of recording a coefficient of a threshold value calculation function, which is an increasing function, for calculating the coring threshold value, and
a function operation step of calculating the coring threshold value on the basis of the relative distance, the noise amount, and the threshold value calculation function.

5. The noise reduction method for the video signal according to claim 3, wherein
the coring threshold value setting step includes
a table recording step of recording a table of a coring threshold value corresponding to the relative distance and the noise amount, and
a table operation step of deriving the coring threshold value from a table recording section on the basis of the relative distance and the noise amount.

6. The noise reduction method for the video signal according to claim 2, wherein
the smoothing step includes
a filter coefficient setting step of setting a filter coefficient on the basis of the relative distance and setting a ratio between the filter coefficient for a pixel of interest corresponding to the video signal of the one subject and the filter coefficient for a neighboring pixel which is a pixel within N pixels (N is an integer not less than 1) from the pixel of interest again on the basis of the relative distance, and
a filtering step of performing low-pass filtering on the video signal on the basis of the filter coefficient.

7. The noise reduction method for the video signal according to claim 6, wherein
the coring threshold value setting step includes
a function recording step of recording a coefficient of a threshold value calculation function, which is an increasing function, for calculating the coring threshold value, and
a function operation step of calculating the coring threshold value on the basis of the relative distance, the noise amount, and the threshold value calculation function.

8. The noise reduction method for the video signal according to claim 6, wherein
the coring threshold value setting step includes
a table recording step of recording a table of a coring threshold value corresponding to the relative distance and the noise amount, and
a table operation step of deriving the coring threshold value from a table recording section on the basis of the relative distance and the noise amount.

9. The noise reduction method for the video signal according to claim 2, wherein
the relative distance calculation step includes
an upper limit setting step of setting an upper limit value for the relative distance, and
a clipping step of replacing the relative distance with the upper limit value if the relative distance is above the upper limit value.

10. The noise reduction method for the video signal according to claim 2, wherein
the shooting step includes
a first shooting step of shooting the subject by the image pickup section and outputting a first video signal and
a second shooting step of shooting the subject by the image pickup section and outputting a second video signal, and
the noise reduction processing is performed on the second video signal on the basis of the shooting distance calculated from the first video signal.

11. An image pickup apparatus comprising:
an image pickup section configured to shoot a subject and output a video signal;
a distance measurement section configured to calculate a shooting distance between the subject and the image pickup section corresponding to the video signal;
a specific distance acquisition section configured to calculate a specific distance which is a shooting distance between one subject of the subject and the image pickup section on the basis of focus information of the one subject;
a relative distance calculation section configured to calculate a relative distance corresponding to the video signal on the basis of the shooting distance and the specific distance; and
a noise reduction section configured to perform noise reduction processing by performing smoothing processing on the video signal on the basis of the relative distance.

12. The image pickup apparatus according to claim 11, wherein
the noise reduction section includes
a noise estimation section configured to estimate a noise amount included in the video signal and
a threshold value setting section configured to set a coring threshold value which is a threshold value used in coring processing on the basis of the relative distance and the estimated noise amount, and
performs the coring processing on the video signal using the coring threshold value.

13. The image pickup apparatus according to claim 12, wherein
the noise reduction section includes
a size setting section configured to set a filter size indicating a position range from a predetermined center pixel such that the filter size monotonically increases with an increase in the relative distance on the basis of the relative distance,
a filter coefficient recording section configured to record a filter coefficient corresponding to the filter size, and
a filtering section configured to read out the filter coefficient from the filter coefficient recording section on the basis of the filter size and perform low-pass filtering on the video signal.

14. The image pickup apparatus according to claim 13, wherein
the noise reduction section includes
a function coefficient recording section configured to record a coefficient of a threshold value calculation function, which is an increasing function, for calculating the coring threshold value, and
a function operation section configured to calculate the coring threshold value on the basis of the relative distance, the noise amount, and the threshold value calculation function.

15. The image pickup apparatus according to claim 13, wherein
the noise reduction section includes
a table recording section configured to record a table of a coring threshold value corresponding to the relative distance and the noise amount, and
a table operation section configured to derive the coring threshold value from the table recording section on the basis of the relative distance and the noise amount.

16. The image pickup apparatus according to claim 12, wherein
the noise reduction section includes
a filter coefficient setting section configured to set a filter coefficient on the basis of the relative distance and set a ratio between the filter coefficient for a pixel of interest to be subjected to the noise reduction processing and the filter coefficient for a neighboring pixel which is a pixel within N pixels (N is an integer not less than 1) from the pixel of interest again on the basis of the relative distance, and
a filtering section configured to perform low-pass filtering on the video signal on the basis of the filter coefficient.

17. The image pickup apparatus according to claim 16, wherein
the noise reduction section includes
a function coefficient recording section configured to record a coefficient of a threshold value calculation function, which is an increasing function, for calculating the coring threshold value, and
a function operation section configured to calculate a coring threshold value on the basis of the relative distance, the noise amount, and the threshold value calculation function.

18. The image pickup apparatus according to claim 16, wherein
the noise reduction section includes
a table recording section configured to record a table of a coring threshold value corresponding to the relative distance and the noise amount, and
a table operation section configured to derive the coring threshold value from the table recording section on the basis of the relative distance and the noise amount.

19. The image pickup apparatus according to claim 12, wherein
the relative distance calculation section includes
an upper limit setting section configured to set an upper limit value for the relative distance, and
a clipping section configured to replace the relative distance with the upper limit value if the relative distance is above the upper limit value.

20. An image pickup apparatus comprising:
an image pickup section configured to shoot a subject and output a video signal;
a distance measurement section configured to calculate a shooting distance between the subject and the image pickup section corresponding to the video signal; and
a noise reduction section configured to calculate a distance weighting factor for the video signal from a difference between the shooting distance for a pixel of interest to be subjected to noise reduction processing and the shooting distance for a neighboring pixel which is a pixel within N pixels (N is an integer not less than 1) from the pixel of interest on the basis of the shooting distance, hold an edge component between regions with a shooting distance difference, and perform high-accuracy noise reduction processing on a video signal other than an edge component.
